(19) United States
(12) Patent Application Publication
(10) Pub. No.: US 2025/0010762 A1
(43) Pub. Date: Jan. 9, 2025

(54) VEHICLE

(71) Applicant: TOYOTA JIDOSHA KABUSHIKI KAISHA, Toyota-shi Aichi-ken (JP)

(72) Inventors: Tsubasa MIGITA, Sakai-shi Osaka (JP); Hiroshi NAGASE, Nagoya-shi Aichi-ken (JP)

(73) Assignee: TOYOTA JIDOSHA KABUSHIKI KAISHA, Toyota-shi Aichi-ken (JP)

(21) Appl. No.: 18/675,712

(22) Filed: May 28, 2024

(30) Foreign Application Priority Data
Jul. 6, 2023 (JP) 2023-111518

(51) Int. Cl. B60L 58/20; B60L 53/22; B60L 58/12

(52) U.S. Cl. CPC B60L 58/20; B60L 53/22; B60L 58/12; B60L 2210/10

(57) ABSTRACT

Vehicles include a main battery, an auxiliary battery, charging relays, a DC/DC converter, and an ECU. The charging relay is used to perform external charging for charging the main battery by the power equipment. The DC/DC converter is configured to step down the discharging power of the main battery and to provide the stepped-down power to the auxiliary battery. ECU controls the DC/DC converter. ECU lowers the charging state of the auxiliary battery from the first state to the second state by the end of the external charging, and drives the DC/DC converter after the end of the external charging.

### CROSS-REFERENCE TO RELATED APPLICATION

This application claims priority to Japanese Patent Application No. 2023-111518 filed on Jul. 6, 2023, incorporated herein by reference in its entirety.

### BACKGROUND

### 1. Technical Field

The present disclosure relates to a vehicle.

### 2. Description of Related Art

Japanese Unexamined Patent Application Publication No. 2022-133689 (JP 2022-133689 A) discloses a vehicle. The vehicle includes an all-solid-state battery (power storage device) and an arithmetic unit. The arithmetic unit calculates the remaining charge level of the all-solid-state battery.

### SUMMARY

Electrified vehicles each generally include a first power storage device for traveling, a second power storage device for auxiliary devices, and a converter. The electrified vehicle may further include a charging device for performing external charging for charging the first power storage device with power equipment outside the vehicle. The converter steps down discharge power of the first power storage device and supplies the stepped-down power to the second power storage device. As a result, the second power storage device is charged.

Continuous charging such as external charging may cause polarization of the first power storage device. In some embodiments, since this polarization causes a decrease in accuracy of estimation of the full charge level of the first power storage device, the polarization is quickly reduced after the end of the external charging.

The present disclosure has been made to solve the above problem, and an object thereof is to provide a vehicle that can quickly reduce polarization of a power storage device for traveling after the end of external charging.

A vehicle of the present disclosure includes a first power storage device for traveling, a second power storage device for an auxiliary device, a charging device, a converter, and a control device. The charging device is used to perform external charging for charging the first power storage device with power equipment outside the vehicle. The converter is configured to step down discharge power of the first power storage device and supply the stepped-down power to the second power storage device. The control device is configured to control the converter. The control device is configured to lower a charging state of the second power storage device from a first state to a second state by an end of the external charging, and drive the converter after the end of the external charging.

With the above configuration, it is easy to drive the converter to such an extent that the polarization of the first power storage device is substantially eliminated. As a result, the polarization of the first power storage device can be reduced quickly.

The discharge power when the converter is driven with the charging state lowered to the second state may be larger than the discharge power when the converter is driven without lowering the charging state to the second state.

It is likely that the polarization of the first power storage device is reduced more quickly as the discharge power of the first power storage device increases. With the above configuration, the polarization of the first power storage device can be reduced (eliminated) more quickly after the external charging.

The control device may be configured to perform an estimation process for estimating a full charge level of the first power storage device. The control device may be configured to, when the converter is driven with the charging state lowered to the second state, perform the estimation process with an interval of a first period or longer after the end of the external charging. The control device may be configured to, when the converter is not driven after the end of the external charging, perform the estimation process with an interval of a second period or longer after the end of the external charging. The first period may be shorter than the second period.

With the above configuration, when the converter is driven with the charging state lowered to the second state, the polarization can be eliminated more securely and the estimation process can be started earlier than in the case where the converter is not driven after the end of the external charging.

The first power storage device may include an all-solid-state battery.

In the all-solid-state battery, reaction unevenness in a depth direction of cells and polarization are likely to occur. With the above configuration, the polarization of the first power storage device can be reduced quickly in the vehicle including the all-solid-state battery in the first power storage device.

According to the present disclosure, it is possible to quickly reduce the polarization of the power storage device for traveling after the end of the external charging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an overall configuration of a vehicle according to an embodiment;

FIG. 2A is a diagram for explaining pumped charge control;

FIG. 2B is a diagram for explaining the pumped charge control;

FIG. 2C is a diagram for explaining the pumped charge control;

FIG. 3A is a diagram for explaining polarization relaxation control;

FIG. 3B is a diagram for explaining the polarization relaxation control;

FIG. 4A is a diagram for describing a process executed by Electronic Control Unit (ECU);

FIG. 4B is a diagram for describing the process executed by the Electronic Control Unit (ECU);

FIG. 4C is a diagram for describing the process executed by the Electronic Control Unit (ECU);

FIG. 5 is a flow chart illustrating an exemplary process associated with external charging; and

FIG. 6 is a flowchart illustrating another example of a process related to external charging.

### DETAILED DESCRIPTION OF EMBODIMENTS

Hereinafter, embodiments of the present disclosure will be described in detail with reference to the drawings. The same or corresponding parts in the drawings are denoted by the same reference numerals, and the description thereof will not be repeated. Each of the embodiments and the modification examples thereof may be combined with each other as appropriate.

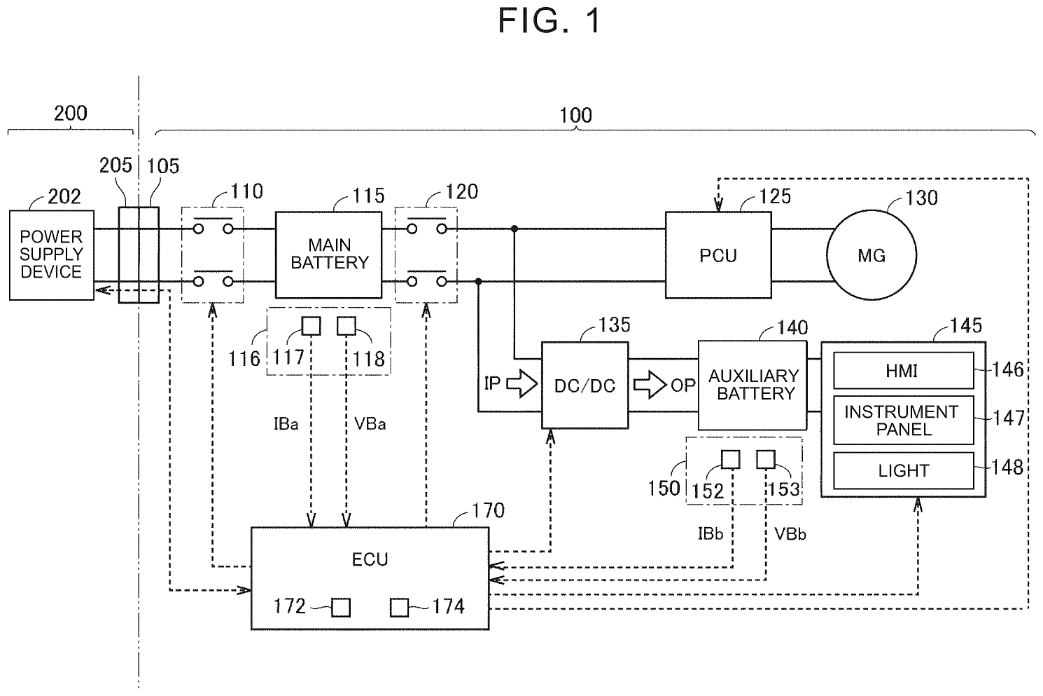

FIG. 1 is a diagram illustrating an overall configuration of a vehicle according to an embodiment. Referring to FIG. 1, a vehicle 100 is a Battery Electric Vehicle (BEV) and is connected to power equipment 200. The power equipment 200 is provided outside the vehicle 100.

The vehicle 100 includes an inlet 105, a charging relay 110, a main battery 115 (first power storage device), and a sensor unit 116. The vehicle 100 further includes a System Main Relay (SMR) 120, a Power Control Unit (PCU) 125, and a Motor Generator (MG) 130. Vehicle 100 further includes a DC/DC converter 135, auxiliary battery 140 (second power storage device), auxiliary equipment 145, sensor unit 150, and ECU 170.

The inlet 105 is connected to a connector 205 of the power equipment 200. The inlet 105 receives power supplied from the power supply device 202 of the power equipment 200. In this example, the feed power is DC power. The charging relay 110 is a charging device for performing external charging of the vehicle 100. The charging relay 110 is controlled to be in a closed state during external charging. The external charging is to charge the main battery 115 by the power supplied from the power supply device 202.

The main battery 115 stores electric power for traveling by the vehicle 100. The main battery 115 is an assembled battery including a plurality of cells. Each cell is a lithium-ion battery, in this example an all-solid-state battery. An all-solid-state battery is a battery having a solid electrolyte layer as its electrolyte layer.

After the end of the external charge, polarization of the main battery 115 may be caused. This polarization is a phenomenon in which the voltage VBa of the main battery 115 temporarily increases. Polarization can increase the error in the estimation of the full charge capacity of the main battery 115. After the end of the external charging, the polarization resolves spontaneously after a sufficiently long period of time. Alternatively, the polarization is mitigated (eliminated) when the main battery 115 is discharged. When the polarization disappears, the polarization is sufficiently relaxed to stabilize the voltage VBa. The above-described polarization is easier to be relaxed as the discharge power amount of the main battery 115 increases, and easier to be relaxed as the discharge power of the main battery 115 increases.

The sensor unit 116 includes a current sensor 117 and a voltage sensor 118. The current sensor 117 detects a current IBa of the main battery 115. The voltage sensor 118 detects a voltage VBa of the main battery 115.

SMR 120 is connected between the main battery 115 and PCU 125 and the DC/DC converter 135. SMR 120 switches between the main battery 115 and PCU 125 and the DC/DC converter 135 by opening and closing.

PCU 125 converts discharging power (DC power) of the main battery 115 into AC power. The MG 130 receives AC power from PCU 125 and generates a driving force for driving the vehicle 100.

The DC/DC converter 135 steps down its input power IP. The input power IP corresponds to the discharging power of the main battery 115. DC/DC converter 135 is configured to provide the stepped-down power to the auxiliary battery 140 as the power OP of DC/DC converter 135. The power OP corresponds to the charge power of the auxiliary battery 140. The DC/DC converter 135 is driven when SMR 120 is closed.

The auxiliary battery 140 stores the operating power of the auxiliary equipment 145. The auxiliary equipment 145 includes a Human Machine Interface (HMI) device 146, an instrument panel 147, and a light 148. Each of these auxiliary devices is a low-voltage electric device, and operates by consuming electric power of the auxiliary battery 140. Each accessory may operate during external charging.

The sensor unit 150 includes a current sensor 152 and a voltage sensor 153. The current sensor 152 detects a current IBb of the auxiliary battery 140. The voltage sensor 153 detects a voltage VBb of the auxiliary battery 140. The higher the charge amount (storage amount) of the auxiliary battery 140, in other words, the higher the state-of-charge of the auxiliary battery 140, the higher the voltage VBb. This charge status is represented by, for example, State of Charge (SOC) of the auxiliary battery 140.

ECU 170 includes a Central Processing Unit (CPU) 172 and a memory 174. CPU 172 executes various arithmetic processes. The memory 174 includes Read Only Memory (ROM) and Random Access Memory (RAM) (both not shown). ROM stores a program executed by CPU 172.

ECU 170 controls various devices of the vehicle 100 in accordance with the currents IBa, IBb and the voltages VBa, VBb. The device includes the charging relay 110, SMR 120, PCU 125, the DC/DC converter 135, and the auxiliary equipment 145.

ECU 170 determines the insertion of the connector 205 into the inlet 105 based on the signal-level from the power equipment 200. ECU 170 calculates SOC of the main battery 115 according to the current IBa and the voltage VBa. ECU 170 sets a target SOC of the auxiliary battery 140 and sets a target voltage of the auxiliary battery 140. ECU 170 controls the input power IP and outgoing power OP by controlling the DC/DC converter 135. ECU 170 commands the start of external charging by transmitting a charging start command to the power equipment 200. ECU 170 commands the end of the external charging by transmitting a charging end command to the power equipment 200.

ECU 170 is configured to be able to execute a process of estimating the full charge capacity of the main battery 115 after the external charge is completed. Hereinafter, this process is also referred to as “estimation process”. The estimation process is performed when SMR 120 is open. The estimation process is executed based on Open Circuit Voltage (OCV) of the main battery 115. The estimation processing is scheduled when a predetermined time elapses from the time when this processing was executed last time (when the full charge capacity was estimated last time). The predetermined time period is, for example, one week. In some embodiments, in a case where the estimation process is scheduled, the polarization is sufficiently relaxed (eliminated) in order to avoid the influence on the estimation result of the full charge capacity due to the polarization of the main battery 115.

ECU 170 performs pumped charge control or polarization relaxation control by controlling SMR 120 to a closed condition to drive the DC/DC converter 135. The pumped charge control and the polarization relaxation control are the same in that the power of the main battery 115 is supplied to the auxiliary battery 140 via the DC/DC converter 135, but differ in their objectives.

The pumping charge control is performed to charge the auxiliary battery 140 using the electric power of the main battery 115 when the voltage VBb decreases. This control may also be performed when the vehicle 100 is running or when SMR 120 is turned off.

The polarization relaxation control is performed for the purpose of discharging the main battery 115 and relaxing the polarization thereof after the completion of the external charging. This control is executed when the estimation processing is scheduled after the end of the external charging. Hereinafter, each of the pumped charge control and the polarization relaxation control will be described in detail.

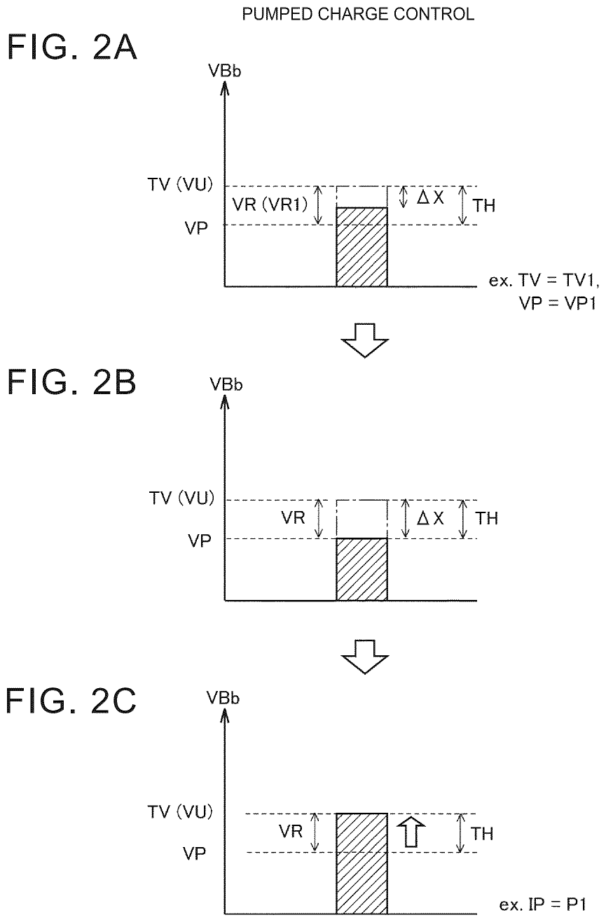

FIGS. 2A to 2C are diagrams for explaining pumped charge control. Referring to FIGS. 2A to 2C, in each of FIGS. 2A to 2C, the vertical axis represents the voltage VBb.

In FIG. 2A, the voltage VBb is less than the target voltage TV of the auxiliary battery 140 by AX. The target-voltage TV is, for example, a TV1. TV1 is equal to the upper limit voltage VU of the auxiliary battery 140, and is, for example, 13 V. The upper limit voltage VU is determined in advance by experimentation or the like from the viewpoint of protecting the auxiliary battery 140. When the voltage VBb reaches the upper limit voltage VU, ECU 170 deactivates the DC/DC converter 135. AX corresponds to the difference between the upper limit voltage VU and the voltage VBb, and is related to the chargeable power of the auxiliary battery 140. In other words, the larger AX, the larger the amount of chargeable power.

In FIG. 2B, the power of the auxiliary battery 140 is consumed and the voltage VBb drops to the starting voltage VP. The starting voltage VP is a predetermined voltage which is lower than the target voltage TV by the reference value TH, and is VP1 in this case. VP1 is, for example, 12 V. When the voltage VBb drops to the starting voltage VP, the pumping charge control starts.

In FIG. 2C, the auxiliary battery 140 is charged by the pumping charge control, and the voltage VBb rises from the starting voltage VP to the target voltage TV. Due to the pumped charge control, the voltage VBb is controlled within the voltage range VR. The voltage range VR is a range of the voltage VBb, and the upper and lower limits of the voltage range VR are determined to be the target voltage TV and the starting voltage VP, respectively. In this instance, the voltage range VR is VR1.

The input power IP during pumped charge control is P1. In other words, when the voltage VBb drops to the starting voltage VP, the DC/DC converter 135 is driven such that the input power IP is P1.

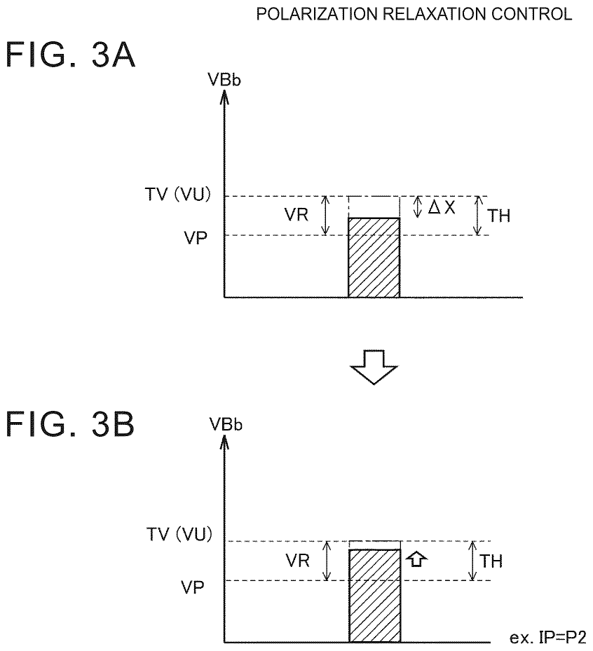

FIGS. 3A and 3B are diagrams for explaining polarization relaxation control. Referring to FIGS. 3A and 3B, in each of FIGS. 3A and 3B, the vertical axis represents the voltage VBb.

In the example of FIG. 3A, the estimation process is scheduled immediately after the external charging is completed. ECU 170 performs polarization relaxation control prior to the estimation process. The polarization-relaxation control is executed until the integrated value of the current IBb from the beginning reaches a predetermined value. The predetermined value is stored in the memory 174, and is appropriately determined in advance by an experiment as a value in which the polarization is eliminated when the integrated value reaches the predetermined value. Due to the polarization-relaxation control, the auxiliary battery 140 is charged, and the voltage VBb increases (from FIG. 3A to FIG. 3B).

The input power IP of the DC/DC converter 135 during the polarization-relaxation control is P2. In other words, when the voltage VBb is less than the target voltage TV (and higher than the starting voltage VP) after the end of the external charge, the DC/DC converter 135 is driven such that the input power IP is P2 prior to the estimation process.

Continuous charging, such as external charging, can cause polarization in main battery 115. In some embodiments, since this polarization leads to a decrease in the estimation accuracy of the full charge capacity of the main battery 115, the polarization is quickly relaxed after the end of the external charge.

In an embodiment, ECU 170 has a configuration for addressing such issues. This point will be described below.

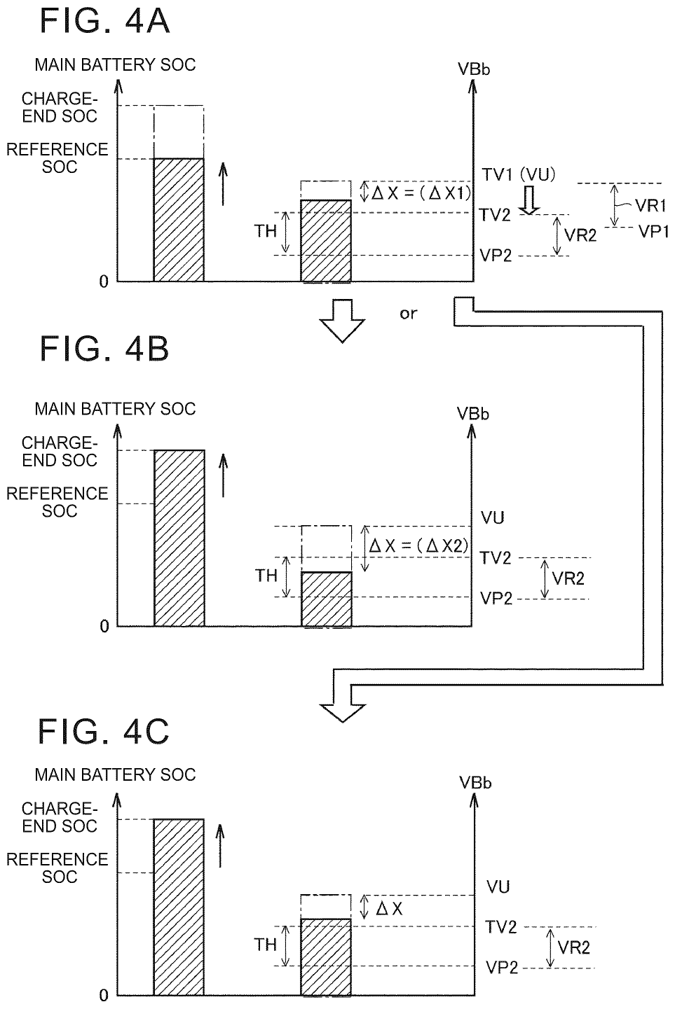

FIGS. 4A to 4C are diagrams for explaining a process executed by ECU 170. Referring to FIGS. 4A to 4C, in the example of FIG. 4A, the external charging is being performed, and AX is AX1. The state of charge of the auxiliary battery 140 when AX is AX1 is also represented as a “first state” (a hatched portion on the right side of FIG. 4A). ECU 170 is scheduled to execute the estimation process by driving the DC/DC converter 135 to execute the polarization relaxation control after the external charge.

When SOC of the main battery 115 rises to the reference SOC, ECU 170 pulls the target-voltage TV of the auxiliary battery 140 from TV1 to TV2. The reference SOC is lower than the charge-end SOC of the main battery 115. For example, the charge-end SOC is 80% and the reference SOC is 60%. TV2 is, for example, 12.5 V. When the target voltage TV is lowered to TV2, the starting voltage VP is also lowered from VP1 to VP2 (e.g., 11.5 V). This lowers the voltage range VR to VR2 (<VR1). As a result, the state of charge (amount of electricity storage) of the auxiliary battery 140 tends to decrease.

Until SOC reaches the charge-end SOC, the auxiliary equipment 145 is activated, so that the power of the auxiliary battery 140 is consumed and the voltage VBb is lowered (from FIG. 4A to FIG. 4B). In FIG. 4B, the voltage VBb is in VR2 and AX is AX2 (>AX1). The state of charge of the auxiliary battery 140 when AX is AX2 is also referred to as a “second state” (a hatched portion on the right side of FIG. 4B). Due to the lowering of the target-voltage TV, the state of charge of the auxiliary battery 140 is lowered from the first state to the second state.

As described above, ECU 170 lowers the charging state of the auxiliary battery 140 from the first state to the second state by lowering the target voltage TV (voltage range VR) from the beginning to the end of the external charging.

When SOC reaches the charge-end SOC, ECU 170 terminates the external charge. After the external charge is completed, ECU 170 drives the DC/DC converter 135 until the integrated value of the current IBb reaches the predetermined value to execute the polarization relaxation control, and then executes the estimation process. When the estimation process is completed, ECU 170 pulls the target-voltage TV back from TV2 to TV1. This causes the voltage range VR to return from VR1 to VR2.

The lower the target voltage TV is, the lower the voltage range VR is, and thus the voltage VBb tends to be lower. The lower the voltage VBb, the larger the AX tends to be. The larger AX is, the larger the chargeable power amount of the auxiliary battery 140 is. The larger the amount of electric power, the larger the amount of dischargeable electric power of the main battery 115. Therefore, the amount of discharge power of the main battery 115 can be increased, and the polarization of the main battery 115 can be easily relaxed.

By lowering the target voltage TV (voltage range VR) as described above, the charge status of the auxiliary battery 140 can be lowered (AX can be increased).

When AX is small, the chargeable power of the auxiliary battery 140 is small, and there is a possibility that the voltage VBb immediately reaches the upper limit voltage VU after the branch relaxation control is started and the DC/DC converter 135 is stopped. As a consequence, a situation may occur in which the DC/DC converter 135 cannot be driven to such an extent that the main battery 115 is substantially depolarized (the discharged power of the main battery 115 cannot be sufficiently secured). This requires that the DC/DC converter 135 be stopped and then wait for a certain period of time until the polarizations are resolved naturally. As described above, when AX is small, there is a possibility that the polarization cannot be rapidly relaxed (eliminated).

On the other hand, in the embodiment, since AX tends to increase, the chargeable power amount of the auxiliary battery 140 tends to increase. Therefore, the above-described situation can be avoided. In other words, it is easier to drive the DC/DC converter 135 to such an extent that the main battery 115 is substantially depolarized. As a result, the polarization of the main battery 115 can be rapidly relaxed as compared with the above-described example of waiting for a certain period of time. Therefore, in a case where the estimation processing is scheduled after the end of the external charging, the estimation processing can be started at an early stage.

The auxiliary equipment 145 may also operate during external charging. In some embodiments, in order to avoid insufficient charge of the auxiliary battery 140, the state of charge of the auxiliary battery 140 is lowered only when necessary. In the embodiment, the target voltage TV (voltage range VR) is lowered only during a time period from when SOC rises to the reference SOC to when the estimation process is completed.

This makes it possible to minimize the length of the period in which the state of charge of the auxiliary battery 140 is low. Therefore, it is easy to avoid a situation in which the charge amount of the auxiliary battery 140 is insufficient.

In some embodiments, ECU 170 controls DC/DC converter 135 such that the discharge power of the main battery 115 when the charging state of the auxiliary battery 140 is lowered to the second state and DC/DC converter 135 is driven (IP of the input power at the time of the branch relaxation control is P2) is several times larger than the discharge power (P1 which is the input power IP at the time of the pumping charge control) when DC/DC converter 135 is driven without lowering the charging state of the auxiliary battery 140 to the second state.

The polarization of the main battery 115 after the external charge is more likely to be relaxed as the discharge power (input power IP) of the main battery 115 increases. By controlling the DC/DC converter 135 as described above, the discharging power of the main battery 115 increases during the branch relaxation control. As a result, the polarization of the main battery 115 can be relaxed (eliminated) more quickly after external charging.

Prior to the estimation process, in some embodiments, SMR 120 is opened for some period of time to continue the unloaded condition of the main battery 115 in order to more reliably eliminate the polarization of the main battery 115 (stabilize the voltage VBa), regardless of whether or not the polarization relaxation control is performed.

Even when the target voltage TV is lowered to less than the voltage VBb, the external charging may be completed in a short time, or the electric power of the auxiliary battery 140 may not be consumed so much during the external charging, so that the state of charge of the auxiliary battery 140 may not be sufficiently lowered (AX is small) at the end of the external charging. Consequently, as in FIG. 4C, the voltage VBb may be greater than or equal to the target voltage TV at the termination of the external charge. In this case, ECU 170 does not execute the branch relaxation control from the viewpoint of preventing overcharge of the auxiliary battery 140, and controls SMR 120 to be open for a certain period of time. During this period of time, the main battery 115 is in an unloaded state. The length of the fixed time (the duration of the unloaded state) is determined in advance as the length of time for which the polarization naturally relaxes without driving the DC/DC converter 135 after the external charge is completed.

On the other hand, as in FIG. 4B, when the state of charge of the auxiliary battery 140 is sufficiently lowered at the end of the external charge, the DC/DC converter 135 is driven until the polarization is substantially eliminated (branch relaxation control is executed). Thereafter, SMR 120 is controlled to the open state, and the no-load state continues. The duration of this unloaded condition (the opening time of SMR 120) is not problematic from the viewpoint of polarization-relaxation even when it is shorter than the duration of FIG. 4C. This is because the polarization of the main battery 115 has already been largely eliminated by the branch relaxation control. ECU 170 controls SMR 120 in the case of FIG. 4B so that the duration of the no-load condition is shorter than in the case of FIG. 4C.

When ECU 170 drives the DC/DC converter 135 by lowering the state of charge of the auxiliary battery 140 from the first state to the second state as in FIG. 4B, the estimation process is executed after the external charge has been completed for a first time or longer. On the other hand, when the DC/DC converter 135 is not driven after the external charging is completed as in FIG. 4C, the estimation process is executed after the external charging is completed for a second time or longer. The first time is shorter than the second time. The first time corresponds to the sum of the execution time of the branch relaxation control and the duration of the no-load state for FIG. 4B. The second period corresponds to the duration of the unloaded state for FIG. 4C.

With such a configuration, in the case of FIG. 4B, it is possible to start the estimation process earlier than in the case of FIG. 4C while further ensuring depolarization.

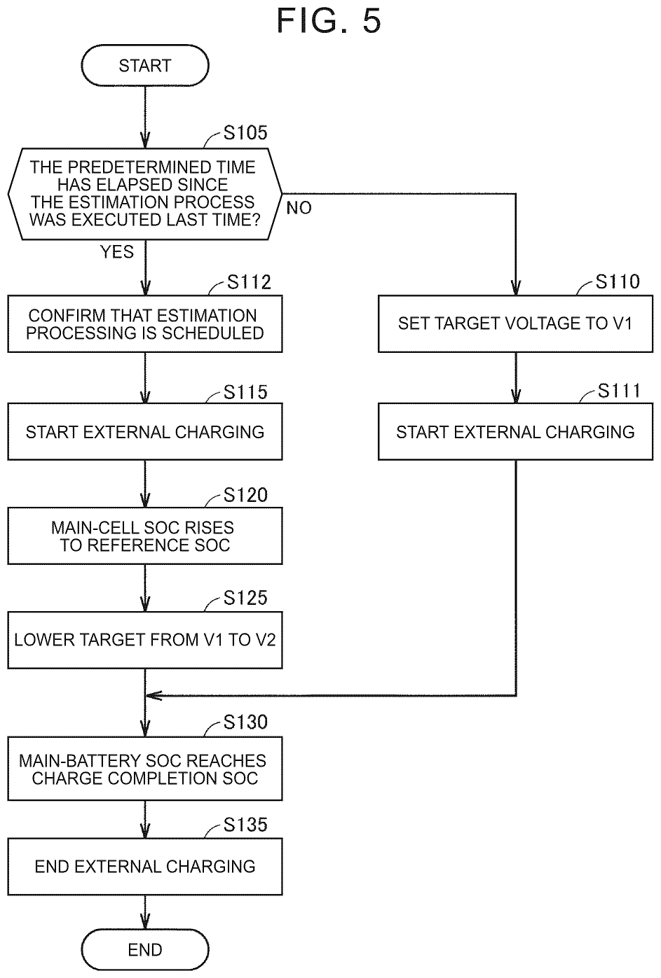

FIG. 5 is a flowchart illustrating an example of a process related to external charging. This flowchart begins when connector 205 is inserted into inlet 105.

Referring to FIG. 5, ECU 170 determines whether a predetermined period of time has elapsed since the estimation process was executed last time (S105). When the predetermined period has not elapsed (NO in S105), ECU 170 sets the target voltage TV to V1 (S110) and starts external charging in response to a user manipulation instructing the start of external charging (S111). Thereafter, the process proceeds to S130. On the other hand, when the predetermined period has elapsed (YES in S105), ECU 170 confirms that the estimation process is scheduled after the external charge (S112). ECU 170 initiates an external charge (S115).

When ECU 170 determines that SOC of the main battery 115 has risen to the reference SOC based on the current IBa and the voltage VBa (S120), ECU 170 lowers the target voltage TV from V1 to V2 (S125) in order to reduce the charge status of the auxiliary battery 140. After that, when ECU 170 determines that SOC of the main battery 115 has reached the charge-end SOC (S130), it ends the external charge (S135).

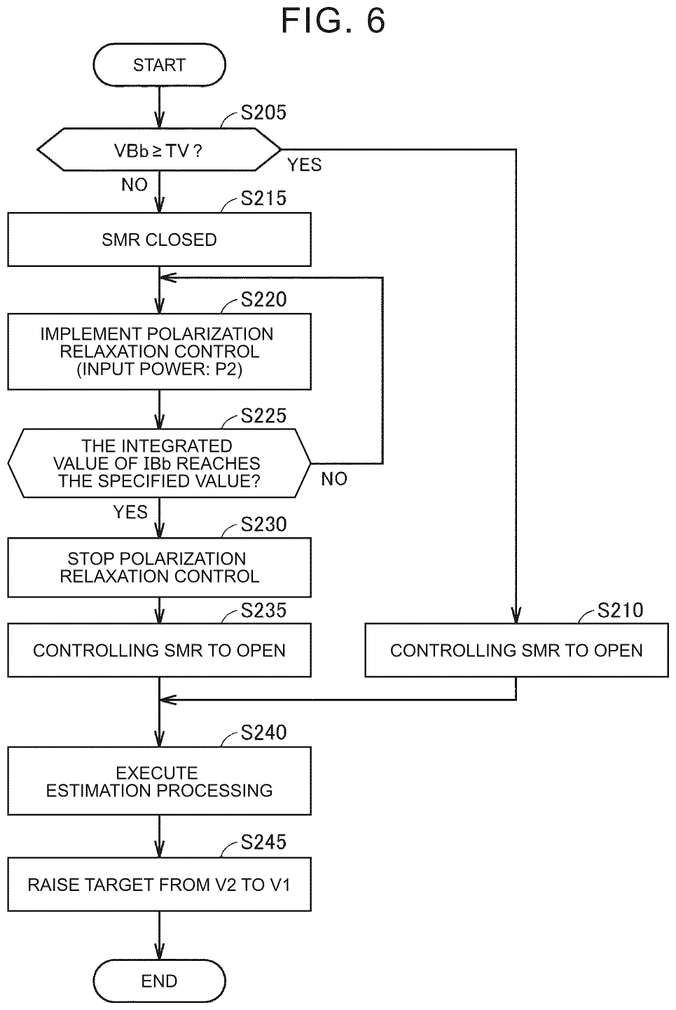

FIG. 6 is a flowchart illustrating another example of a process related to external charging. This flow chart starts after S135 of FIG. 5 when the target-voltage TV is being lowered (S112, S125 is being executed).

Referring to FIG. 6, ECU 170 determines whether or not the voltage VBb at the termination of the external charge is equal to or higher than the target voltage TV (S205). When the voltage VBb is equal to or higher than the target voltage TV (YES in S205) as in the case of FIG. 4C, ECU 170 controls SMR 120 to be in the open state (S210). The execution period of S210 corresponds to the second period described above. After S210, the process proceeds to S240.

If the voltage VBb is less than the target voltage TV (NO in S205), as in FIG. 4B, ECU 170 controls SMR 120 to be closed (S215) and performs polarization-relaxation control (S220). This control is performed when the input power IP is P2 (>P1). In FIG. 6, it is assumed that the voltage VBb does not decrease to the starting voltage VP (the pumping charge control is not executed).

ECU 170 determines whether or not the integrated value of the current IBb has reached a predetermined value (S225). When the integrated value has not reached the predetermined value (NO in S225), the process returns to S220, and the polarization-relaxation control continues. When the integrated value reaches the predetermined value (YES in S225), ECU 170 stops the polarization-relaxation control (S230) and controls SMR 120 to open (S235). S215 to S235 run period corresponds to the first period described above.

ECU 170 uses the voltage VBb after S210 or S235 as OCV of the main battery 115 to perform an estimation process (S240). After S240, ECU 170 pulls the target-voltage TV from V2 to V1 (S245).

As described above, according to the embodiment, ECU 170 lowers the charging state of the auxiliary battery 140 from the first state to the second state by lowering the target voltage TV (voltage range VR) by the end of the external charging, and drives the DC/DC converter 135 after the external charging to execute the polarization relaxation control. As a result, the DC/DC converter 135 is easily driven to such an extent that the main battery 115 is substantially depolarized (it is easy to sufficiently secure the discharged power of the main battery 115). As a result, the polarization of the main battery 115 can be rapidly relaxed.

In particular, the all-solid-state battery is susceptible to polarization. Therefore, the embodiment is particularly effective for a vehicle equipped with an all-solid-state battery.

After continuous charging such as external charging, reaction unevenness (deviation of distribution of lithium ions) may be caused in the depth direction of a cell (all-solid-state battery) of the main battery 115. When the reaction unevenness is caused, the vicinity of the electrode of the cell tends to locally enter a high voltage state. Such a high voltage condition lasting for a long period of time can lead to cell degradation. Therefore, it is important not only to relax (eliminate) the polarization after the external charging, but also to eliminate the above-described reaction unevenness. According to the embodiment, it is easy to drive the DC/DC converter 135 until the voltage in the vicinity of the cell electrode falls to such an extent that degradation of the cell can be prevented after the external charge. Therefore, in addition to the relaxation of the polarization of the main battery 115, the deterioration of the cell can be suppressed.

### OTHER VARIATIONS

The vehicle 100 is not limited to BEV and may be other types of electrified vehicle such as Plug-in Hybrid Electric Vehicle (PHEV).

The power supply of the power supply device 202 may be AC power. The vehicle 100 includes an AC/DC converter as an in-vehicle charger. AC/DC converter converts the AC power to DC power for charging the main battery 115. AC/DC converter and the charging relay 110 also form an exemplary “charging device” of the present disclosure.

Each cell of the main battery 115 is an all-solid-state battery, but may be a liquid-based battery such as a liquid-based lithium-ion battery.

The lowering of the state of charge of the auxiliary battery 140 from the first state to the second state corresponds to the lowering of the target voltage TV from TV1 to TV2, but may be the lowering of the target SOC of the auxiliary battery 140 from the first SOC to the second SOC. The first SOC corresponds to TV1. The second SOC corresponds to TV2.

It should be considered that the embodiments disclosed above are for illustrative purposes only and are not limitative of the disclosure in any aspect. It is intended that the scope of the disclosure be defined by the appended claims rather than the foregoing description, and that all changes within the meaning and range of equivalency of the claims be embraced therein.

What is claimed is:

1. A vehicle comprising:
a first power storage device for traveling;
a second power storage device for an auxiliary device;
a charging device configured to perform external charging for charging the first power storage device with power equipment outside the vehicle;
a converter configured to step down discharge power of the first power storage device and supply the stepped-down power to the second power storage device; and
a control device configured to control the converter, wherein the control device is configured to:
lower a charging state of the second power storage device from a first state to a second state by an end of the external charging; and
drive the converter after the end of the external charging.

2. The vehicle according to claim 1, wherein the discharge power when the converter is driven with the charging state lowered to the second state is larger than the discharge power when the converter is driven without lowering the charging state to the second state.

3. The vehicle according to claim 1, wherein:
the control device is configured to perform an estimation process for estimating a full charge level of the first power storage device;
the control device is configured to:
when the converter is driven with the charging state lowered to the second state, perform the estimation process with an interval of a first period or longer after the end of the external charging, and
when the converter is not driven after the end of the external charging, perform the estimation process with an interval of a second period or longer after the end of the external charging; and
the first period is shorter than the second period.

4. The vehicle according to claim 1, wherein the first power storage device includes an all-solid-state battery.
